(19) United States
(12) Patent Application Publication
(10) Pub. No.: US 2023/0256589 A1
(43) Pub. Date: Aug. 17, 2023

(54) SYSTEM OF SUBDERMAL AND SKIN-LIKE EPIDERMAL OVER-MOLD LAYERS FOR A MODULAR ROBOTICS SYSTEM AND METHOD OF FABRICATION

(71) Applicant: Nicole Alexandria KOHM, MORRISON, CO (US)

(72) Inventor: Nicole Alexandria KOHM, MORRISON, CO (US)

(21) Appl. No.: 18/168,431

(22) Filed: Feb. 13, 2023

Related U.S. Application Data
(60) Provisional application No. 63/289,103, filed on Dec. 13, 2021.

(51) Int. Cl. B25J 9/00; B29C 45/00; B29C 45/14; B25J 9/10

(52) U.S. Cl. CPC B25J 9/0012; B29C 45/0017; B29C 45/0001; B29C 45/14819; B25J 9/1075; B29C 2045/14139; B29C 2045/0022; B25J 9/08

(57) ABSTRACT

A construction of a telepresence robotics platform with polymeric and biomimetic over-molded tissue analogues, optimized for having the compressive, sensate, mechanical, functional, and tumescent properties of bone, cartilage, tendons, organs, muscle, fat, skin, and erogenous tissue, with options for adjustment thereof based on an operator's needs of inertial latency and center of gravity via various selected epidermal layer densities.

### TO ALL WHOM IT MAY CONCERN

Be it known that I, Nicole Alexandria Kohm, a citizen of the United States, have invented new and useful improvements in a subdermal over-mold and skin-like epidermal over-mold for a robotics platform as described in this specification. Within this specification is provided a novel and non-obvious invention's information that would enable a person skilled in the art to produce and utilize this system of subdermal over-molds and skin-like epidermal over-molds for a modular robotics system. It is stated here that although exemplary embodiments are illustrated in the figures and descriptions thereof, the use of and/or phrasing and language regarding specific components or advantages from additional embodiments should be considered as inclusive and non-limiting of the inventive concept contained herein.

### COPYRIGHT NOTICE

Some portions of the disclosure of this patent document may contain material subject to copyright protection. The copyright owner has no objection to the facsimile reproduction by anyone of the patent document or ensuing disclosure as it appears on record at the Patent and Trademark Office, but otherwise reserves all copyright rights whatsoever.

### BACKGROUND OF THE INVENTION

An exemplary telepresence robotics system aims to create remotely controllable robots that attempt to faithfully mimic the physical movements of an operator. The operator is able to control the robot remotely by effectuating biomechanical movements, while wearing the proper equipment, which are then emulated by the robot. An operator performs a physical motion which is translated via mechanical receptors and/or sensors, as well as visual capture, wirelessly over a network, or a direct, connection to a corresponding robot (or multiple robots on the same connection), which expresses the same biomechanical movement in like physical capacity and with like physical intensity. When an operator extends a hand or raises a limb, so too will the telepresence robot extend a hand or raise a limb, in accurate biomimetic mimicry of the action taken by the operator and with an equivalent amount of speed and/or force. It should be noted that the mimicked movements effectuated by a telepresence robot may not always be identical to that of the operator due to differences in situational aspects in the locality, such as when the telepresence robot's operation may require the automated, mimicked movement to account for, correct for, and/or accommodate for differences in terrain, topography, as well as the presence (or absence) of objects being interacted with. For example, a telepresence robot may alter a biomechanical movement of the operator in order to maintain the robot's balance, to resist wind or weather (or other external forces not present at the operator's location), or to compensate for objects that the operator may be interacting with but that are absent from the telepresence robot's vicinity.

Additionally, certain electroreceptors may be coupled with, or to, the brain of the operator whereby the operator's thought or ideation of making a movement is translated as a corresponding, actual movement to the telepresence robot. An operator can achieve a somewhat robust interface with the telepresence robotics system via virtual reality (VR), first-person view (FPV) technology, or haptic feedback drives whereby the operator will be capable of seeing and feeling what the telepresence robot “sees” and “feels.”

In this manner, a telepresence robotics system will enable social and physical interaction between end users expressing themselves through operations of a telepresence robotics system. However, a high-quality experience requires immense customizability and versatility in the creation, design, and overall product output. A human operator must be able to feel as though they are at an event, or experiencing some activity, without actually traveling there. As such, the ability exists to accurately and effectively represent oneself through personal choice in bodily appearance is of vital importance, but shouldn't overshadow the importance of technical factors affecting the immersive capability of a telepresence robotics system, namely system latency, pose-matching precision and accuracy, as well as intuitive biomechanical mimicry.

While telepresence robotics systems are known in the art, many lack intuitive and robust biomechanical mimicry capabilities due to the construction of their frames, materials and, more importantly, the lack of substantial customizability in their overall design negatively affecting operation. Many are constructed utilizing time-consuming methods of manufacturing, while others lack fine control of the robot's overall mass, inertia, and its limbs' degrees of freedom, thus resulting in unintuitive responsivity with latency issues abound.

What is needed to improve both the level and quality of, as well as the ability to effect, interactions between telepresence robots (and the operators thereof) is a system of subdermal over-mold(s) for a robot that mimics the feel and capability of musculature and epidermal skin-like over-mold(s) that mimics the touch and feel of skin. What is needed is a system of subdermal over-mold(s) and a skin-like epidermal over-mold(s) for a robot that encapsulates the load-bearing skeletal frame of a robot and presents a yielding exterior that resembles flesh and organic muscle/tissue, for example human or animal skin, in touch and in feel. Additional embodiments contemplated herein include humanoid forms as well as animal forms having a yielding exterior that resembles human or animal skin (such as reptilian scaled skin, amphibious skin, avian feathered skin, or mammalian furred skin) in both touch and feel.

These systems of over-mold layers are capable of being strategically modified without altering the ease of manufacture based on alterations in density, such as by aerating or foaming the underlying polymer-based material, as well as by substituting material types to accomplish different objectives, such as making the system biodegradable/recyclable or lighter and therefore less prone to operational issues. The ability to specifically control the mass, density, size, and shape of the over-mold layers will enable the robots to accurately translate operators' biomechanical movements with reduced inertial latency and improved immersive interactive experiences.

### FIELD OF THE INVENTION

The present invention relates to a system, and method of production, of subdermal over-mold and skin-like epidermal over-mold layers for a modular robotics system. The present invention is devised to present accurate biomimicry in touch and feel for physical and tactile interaction between users and operators translating biomechanical movements, as well as experiences related thereto, accurately over network, or direct connection between an operator and their robotic system(s), exemplified herein utilizing telepresence robotic systems.

### SUMMARY OF THE INVENTION

The present invention relates to a system, and method of fabrication, of polymeric over-mold layers disposed to encapsulate a modular robotic system, namely the skeletal frame and all technological components therein and thereon as are required to effectuate proper operation. This system of over-mold layers may include aerated or foamed polymer having a yielding and soft exterior surface for tactile and physical contact with and between other users. Such aerated foam is contemplated to reduce latency of biomechanical mimicry due to its reduced mass and density in simulating the look and feel of flesh, whether human or animal, whereby articulation of the modular robotic system is effectuated with less power required and pose matching may be effectuated closer to real time.

The system of over-mold layers may include a skin-like epidermal over-mold layer rendered of silicone, or other polymer, that is devised to resemble human or animal skin in both appearance and feel, with some embodiments including polymeric resin grown to resemble hair. The system of over-mold layers may include a subdermal over-mold layer, similar to human and/or animal subdermal physiology, to render a relatively yielding muscular, yet pliable, body faithfully representing human and/or animal characteristics and encapsulated by said silicone, or other polymer-based, skin-like (outermost) epidermal over-mold layer.

The present invention, therefore, combines structural rigidity required to support load-bearing functionality of a modular robotics system with the yielding exterior desirable for tactile interaction with a human being. The purpose is to provide convincing biomimicry, not just in biomechanical or other movement, but also in appearance and feel, whereby a telepresence robotics system may be interacted with, by and between an operator and other users. The system of polymeric over-mold layers are rendered to accommodate the biomechanical movements of the telepresence robotics system without impeding its potential range of motion based on its skeletal framework and technological components therein and thereon. The system of polymeric over-mold layers is also contemplated as enabling shielding, or protection, of internal components, such as by encapsulating them directly and impermeably or by creating a void for them to operate within.

In some embodiments contemplated herein, a rigid or semi-rigid robotic system's frame is subjected to the constructed addition of an over-mold layer disposed to cover at least part of it, including both the skeletal load-bearing components as well as the electrical/technological operative components. This may be accomplished via the use of needle-like and screw-like protrusions that can be attached to the underlying robotic skeletal framework to hold it in place within the mold while the polymeric solution encompasses the robotic system, in whole or in part depending on the method of fabrication being utilized. Once the subdermal over-mold layer has been formed and solidifies in place, the protrusions may be removed and the channels, or voids, left in their place may be utilized for the movement of fluids, the inclusion of additional body component analogues, or they may be filled with a separate layer of polymeric over-mold.

The over-mold layer is envisioned as being of a thickness devised to pad the frame and render contouring similar in appearance and touch to equivalent portions of the human and/or animal body. For example, a robotic system's arm-equivalent may be covered in a polymeric subdermal over-mold layer that includes a shoulder and upper arm portion with contours resembling the biceps and triceps muscles, with an elbow molded to enable flexion and extension of the forearm relative to the upper arm, while encompassing the underlying frame with at least some amount of polymeric over-mold. The polymeric over-mold layer of the forearm may be devised to resemble the shape and contour of the human forearm, including resembling the musculature of the human forearm, such as, the shape and feel of the forearm as rendered by the radialis longus, the flexor carpi ulnaris, the brachioradialis, and other musculature informing the human-replica forearm's dimensions and proportions. The same is contemplated for the remainder of the modular robotics system, to create a torso with humanoid (or at least organic) appearance and feel, lower limbs, upper limbs, neck and head. Realistic orifices are contemplated, such as a mouth, nose, ducts, and pores. Realistic genitalia are contemplated, for example a telepresence robotic system's genitalia capable of mimicking states of arousal and/or tumescence as experienced by an operator.

It is further contemplated that parts of the robotic system's frame may be over-molded to represent fantastical limbs or organs, as well as combinations of human and animal features. For example, a humanoid telepresence robotic system may be equipped with wings, exaggerated or combined limbs, fantastical genitalia, or other elements that are absent in the real world. The polymeric epidermal over-mold layer may be configured to represent different skin textures corresponding to differing body parts such as, the difference in feel of glabrous versus hairy skin, the stratified squamous epithelium (the vermillion border comprising the lips), the perianal skin, the skin of the labia minora, the mucosa, or different epidermises of different animals/species of animals.

Further, both of the polymeric over-mold layers may present a matrix for housing and/or supporting rigid, semi-rigid, as well as soft components of a modular robotics system (both mechanical and electrical). An example being the presence of hydraulically amplified self-healing electrostatic actuators (HASELs), in combination with other technological components, which enable effective mimicry of biomechanical movements by representing muscles, tendons, ligaments, and/or other organic animalistic internal structures, such as by utilizing polymeric sheathes and/or carbon-based conduit tubing as skeletal framework wherein filaments (or other wiry materials) may pass through, or around, to accommodate biomechanical movement. The system of over-mold layers may, therefore, provide a matrix for integration with existing modular robotics systems as well as surrounding, protecting, and/or mollifying rigid and/or semi-rigid robotics structures, such as supports, levers, joints, hardware, motors and wires. The system of over-mold layers may further be adapted to include housings, spacings, and conveyances for such structures, such as an accommodating filament-based muscle analogue capable of applying torque to limbs and joints by action of internally situated and appropriately housed motors in connection with other technological components.

While it is possible to include many components in the skeletal framework, either attached thereto or enclosed therein, the present invention envisions some embodiments as being constructed utilizing sacrificial materials, such as wax or photoresist, or by under-molding specific areas (also referred to herein as spacing or providing voids) in order to create certain channel features within the polymeric over-mold flesh/tissue/muscle analogue which will become pathways for coolants and/or fluids (such as for use as aesthetic, intimate, or functionally representative of blood, mucus, or sweat). Additionally, these channels may vary in size to allow for tumescent operation of pneumatic and/or hydraulically actuated tissue, such as the nipple or phallus, and to allow for the possible creation of micro-channels constructed during the entire over-mold system's manufacturing process to include the ability of modular robotic systems to possess blood vessels, epidermal pores, and other orifices (such as the nose, sweat pores, or tear ducts) capable of outputting analogues of blood, sweat, mucus, and tears (amongst other unstated but equally considered human or animal features). Some embodiments of the system of over-mold layers are contemplated to utilize biodegradable, or otherwise readily recyclable, materials with minimal processing or changes to the manufacturing process required.

In an example embodiment contemplated herein, the subdermal over-mold is envisioned as having a density lower than that of human or mammalian tissue to enable lighter body parts requiring less force to mobilize the mass with equivalent acceleration. Aerating the subdermal over-mold material may allow for the lessened density while accurately representing the appearance and feel compared to human, humanoid, or animal musculature and tissue composition. Similarly, aerating or otherwise lessening the density of the skin-like epidermal over-mold will reduce the overall mass while allowing the retention of tactile and visual resemblance to human, humanoid, or animal skin. The subdermal over-mold is contemplated as enabling movement of articulated joints whereby the over-mold layers are envisioned as including voids, creases, portions with intentionally increased flexibility, or other structures devised to enable compression, flexion, extension of limbs and body parts without causing undue stress, strain, tearing, or breakages. Tumescence of various body parts (such as nipples and genitals, in part or in whole) are contemplated, in the example embodiment illustrated below, as being effectuated by pneumatic and/or hydraulic systems devised to pump a fluid into and out of the corresponding organ. The system of over-mold layers is devised to accommodate and house such structures, thereby enabling transfer of the fluid from a reservoir, or, in some embodiments, from the ambient environment, through various conduits, channels, or conveyances into the corresponding over-molded organ.

An exemplary method contemplated for the manufacture and installation of subdermal over-mold upon a modular robotics system, and all technological/electronic components present thereon and therein, includes the use of a meshed protective cover and molds. Wherein the polymeric-based material encompasses the skeletal framework and cures/cools within the mold, which constrains its movement and frames its formation. The meshed cover may be selectively applied to various portions of the robotic system's framework and tuned to achieve selective ingress mounting and various other constraints. In order to secure the skeletal frame in the requisite position prior to molding, the use of scaffolding protrusions or blades, such as flat sheet steel with rolled edges and clasps or screw threaded needles, are also potential components that may be utilized. Spaces and voids are common throughout the subdermal over-mold layer as joints requires extra room for rotation and movement, in addition to the inclusion of higher density molded parts injected to compensate for the extra load-bearing requirements placed upon joints within a human or animal body. Additionally, such spaces and voids allow for injection molding or the incorporation of additional molding in subsequent ancillary molding steps. This subdermal over-mold construction process can either be accomplished for the entirety of the skeletal frame, or for individual limbs with the final system constructed at a later date.

Thus, has been broadly outlined the more important features of the present telepresent robotics having polymeric subdermal and skin-like epidermal layers so that the detailed description thereof that follows may be better understood and in order that the present contribution to the art may be better appreciated.

### BRIEF DESCRIPTION OF THE DRAWINGS FIGURES

FIG. 1 is an aerial cross-section view of an example embodiment of a humanoid arm portion of a modular robotics system wherein example steps of a method of fabrication of subdermal and skin-like epidermal over-molded layers encapsulating skeletal framework and its joint portions are shown.

FIG. 2 is a perspective cross-section detail view of the interior area of the example embodiment humanoid arm's elbow joint, with portions of the connected humerus and forearm skeletal framework included, wherein the subdermal over-mold encapsulates the underlying technological and electrical components of a humanoid arm while forming the structural and muscular attributes thereof.

FIG. 3 is a perspective cross-section view of an example embodiment of the subdermal over-mold and encapsulated structural components, such as fluid channels, pumps, and diaphragms required to accommodate the construction of a humanoid female breast capable of tumescence, with the inclusion of epidermal skin-like over-mold layer encompassing the entirety of the breast.

FIG. 4 illustrates an example embodiment of capillary channel analogues wherein fluids flow into, and throughout, the capillary channels formed during the fabrication of the epidermal skin-like over-mold layer, thereby causing the subsurface light scattering effect in the cured and set polymeric layer to resemble blushing.

FIG. 5 illustrates a perspective cross-section detailed view of the interior area of an example embodiment of the subdermal and epidermal over-mold layers, with the envisioned technological components required therein, exemplifying some contemplated means to accommodate the skeletal and musculature structure of a humanoid wrist capable of bending and flexing.

FIG. 6 illustrates a perspective cross-section detail view of the interior area of an example embodiment of the subdermal and epidermal over-mold layers, with the envisioned technological components required therein, exemplifying some contemplated means to accommodate the skeletal and musculature structure of a humanoid knee capable of bending and flexing.

FIG. 7 illustrates a cross-sectional view of an exemplary over-molding process wherein the modular robotic framework contains compliant anchor points that are utilized by the scaffolding protrusions to hold the robotic elements in place while the over-mold layer encompasses the framework and cures within the mold.

FIG. 8 illustrates a detailed view of an example embodiment of a hair-like photo-resin filament protruding from beneath the skin-like epidermal over-mold layer and growing through the over-mold while it solidifies, to lie atop the over-mold layer, and thus convey the look and feel of natural human skin hair.

FIG. 9 illustrates a cross-sectional view of an exemplary subdermal over-molding process, of a humanoid phallus, wherein scaffolding protrusions are anchored to the modular robotic system's framework as it sits within the mold ready to be encompassed by the polymeric over-mold resin.

FIG. 10 illustrates a cross-section view of an exemplary subdermal over-molding process of a humanoid phallus in both tumescent and non-tumescent embodiments.

### DETAILED DESCRIPTION OF THE DRAWINGS

The present drawings are included to exemplify embodiments of the instant invention's system and method of fabrication of subdermal and skin-like epidermal over-molded layers atop a modular robotics framework, and are not intended to set forth limiting embodiments. The present drawings set forth conceptual modes of the invention when reduced to practice and are provided to inform persons of ordinary skill in the art, these figures are in no way meant to limit or exclude other contemplated embodiments not illustrated. Thus, additional forms are contemplated, whether humanoid, animal, fantastical, or any combination of the same, and various embodiments of the over-mold contemplated herein in different forms and capacities should be considered as within scope of the drawings shown where the general concept is not contradicted. Thus, “skin-like” epidermal layers as shown may comprise textures and appearances other than that of human skin particularly, such as the papery feel of reptiles, or the appearance of scales, or fur growth from within/beneath the epidermal layer resembling certain mammals.

In the example embodiments set forth herein, it is contemplated that, in most embodiments exemplified, the skin-like epidermal over-mold will be between 1 and 3 mm in depth. The skin-like epidermal over-mold may have a density as low as 0.013 g/cm³. Foam components are contemplated to have a density of approximately 0.02 g/cm³. Denser foams used in subdermal portions may be 0.1 g/cm³. Silicone components, where incorporated, may have a density of approximately 1.1 g/cm³. It is contemplated that particular parts of the over-mold will be configured to biomimetically resemble animal skin, whether reptilian, mammalian, glabrous or hirsute, or even fantastical, as case may be. The overall weight of the over-molded modular robotics framework is contemplated to be approximately 20 to 40 kg. In at least one example embodiment contemplated herein, the upper portions of the over-molded modular robotics framework is contemplated to be rendered in lower density foam than the lower portions, whereby the load-bearing portions of the framework is buttressed by denser foams. Metallic or denser materials may be incorporated to weight the framework down, such as 100 to 500 grams of stainless steel, say, on the bottom of the feet, or incorporated into the over-mold encompassing or embodying the feet.

The forgoing general properties of the over-mold, subdermal and epidermal layers, is included for the purposes of example only. Different or varying densities are contemplated as informing the general concept expressed herein, as set forth generally in the accompanying Figures.

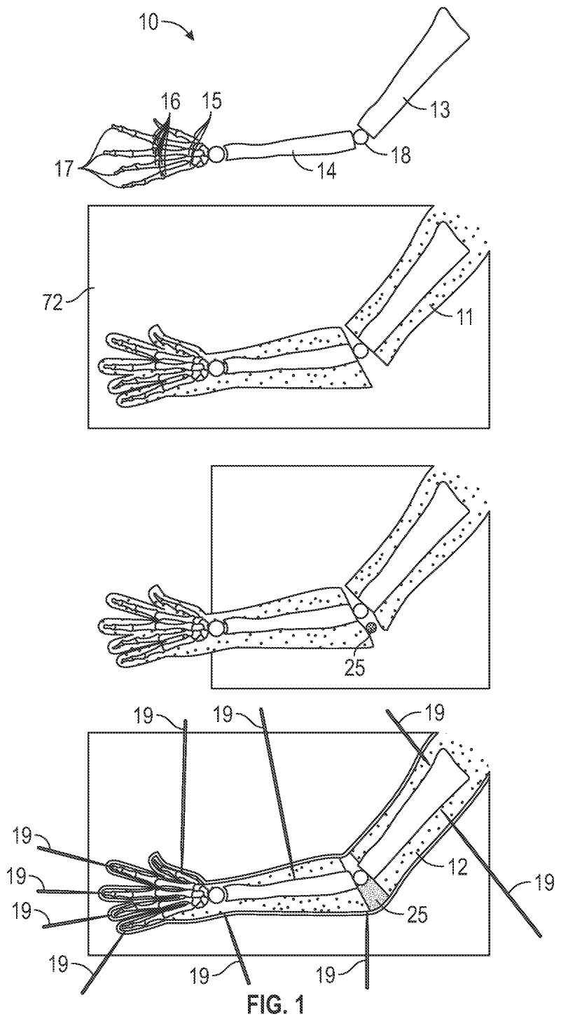

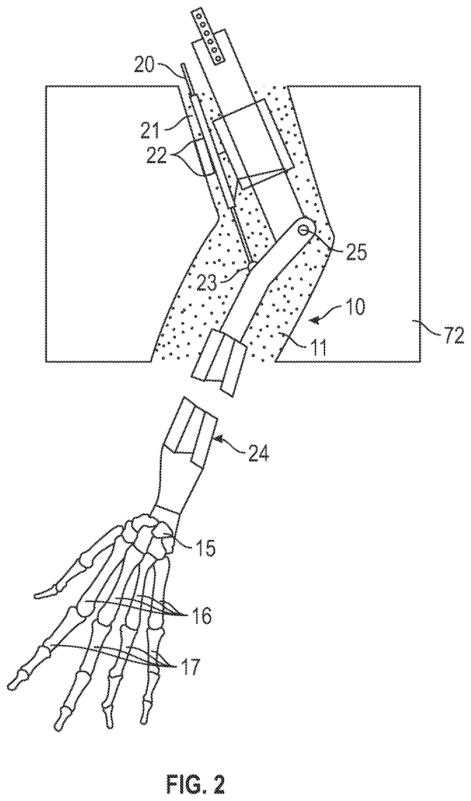

Referring, then, to FIG. 1, an aerial cross-section of a robotic limb designed to resemble a humanoid arm 10 is shown throughout various stages of its formation and development. The following structural skeletal elements are encapsulated in subdermal over-mold 11 beneath epidermal over-mold 12: humerus skeletal element 13, forearm skeletal element 14, carpal skeletal element 15, metacarpal skeletal element 16, phalanges skeletal element 17. Positioned betwixt, and connected to, humerus skeletal element 13 and forearm skeletal element 14 sits elbow joint 18. Prior to formation of subdermal over-mold 11 atop it, the skeletal framework of the modular robot system may include a power supply, motors, actuators, filament housing, sensors, and other electronic assemblies (as illustrated in FIG. 2) required for the robot to effectively mimic the biomechanical actions of the operator. The robotic system's skeletal framework, and requisite electronics assembly 24 attached thereto, is held in place via scaffolding protrusions 19 as subdermal over-mold 11 polymer forms atop all components of the humanoid arm 10. These scaffolding protrusions 19 may be removed from one face of subdermal over-mold 11 after it expands and sets during the curing process, and due to their orientation parallel to the demolding vector they leave cuts and voids within subdermal over-mold 11, which are easily filled, covered, and/or converted into operational channels and utilized in later stages of construction.

Subsequent to the formation of subdermal over-mold 11 over humanoid arm 10, including all robotic skeletal framework elements and electronics assembly 24 therein, a selective reduction to negative mold space (or over-mold voiding) occurs in the region surrounding elbow joint 18, as well as other areas of humanoid arm 10 that require either lack of an over-mold or presence of an over-mold foam of a different density to achieve proper levels of operational flexibility and rotation without experiencing deformation, stress, strain, or other adverse effects that would result in limbic failure or require repair/replacement of both over-mold layers. Likewise, over-mold voids due either to negative mold spacing or scaffolding protrusion presence may be maintained to enable injection molding or incorporation of additional molding, of varying composition or density, in ancillary stages of formation.

Where subdermal over-mold 11 comprises an aerated, or foamed, polymeric layer adapted to resemble the hardness of human or mammalian musculature, skin-like epidermal over-mold 12 is comprised of a similarly aerated polymeric layer adapted to resemble human skin in appearance, touch, and feel. Subdermal over-mold 11 may require varying degrees of aeration to reduce density and mass of certain brachial portions, compared to the maintenance of regular or high density in others, to enable movement of humanoid arm 10 (and other parts of the modular robotic system not illustrated in the present application's illustrations, but equally contemplated herein) at lower accelerations to produce the same force originated by the operator. In the example embodiment, a channel devoid of over-mold may act as an injection port to enable introduction of high-density foam (polymeric molding) into a specific void adjacent to elbow joint 18 whereby simulation of an olecranon of the elbow is produced upon curing and setting. Additional ancillary molding is contemplated as within the scope of the present invention to precisely inject, or position, foam (polymeric molding) within subdermal over-mold 11 thereby simulating various parts of the skeletal/muscular physique of a human as well as encapsulating or housing particular internal structures.

The final molding stage of the fabrication of humanoid arm 10 sees epidermal over-mold 12 composed around a pre-cured subdermal over-mold 11, and is envisioned in this example embodiment to be silicone (or another polymer exhibiting equivalent or proximal material qualities). This is accomplished through the use of a plurality of small needle or screw-like scaffolding protrusions 19, which penetrate the already present polymeric mold and foam layer to act as temporary support and thus keep those layers from distorting or deforming while uncured liquid polymer (silicone in the present embodiment) covers humanoid arm 10. After epidermal over-mold 12 has cured and set, the scaffolding protrusions 19 are removed and humanoid arm 10 undergoes testing of flexibility, strength, and quality of fabrication/formation.

As shown in FIG. 2, subdermal over-mold 11 within humanoid arm 10, specifically illustrated on and around elbow joint 18, is capable of including housings and/or otherwise accommodating conveyances for various structures required to effectuate movement, such as elbow joint pivot 25 which allows for a degree of freedom of revolution for elbow joint 18. Pertaining to the area surrounding this illustrated example embodiment of elbow joint 18 within humanoid arm 10, muscle filament 20 is coated in mold-release and runs through conduit tube 21, which is held in place during the molding process by sacrificial scaffolding 22, until it reaches forearm anchor point 23, which will allow for the exertion of torque on elbow joint 18 by motors and HASEL actuators (not illustrated) responsive to biomechanical actions of the operator, thus resembling the coordinated movements of tendons and muscles within the human body.

Within this illustrated example embodiment, elements resembling conduit tube 21 are included in subdermal over-mold 11 layer to house wires and moving parts (not illustrated) required to enable the articulation of mimicked biomechanical motion sent from the robotic system's operator. Conduit tube 21, and structural elements comparable thereto located throughout the present invention, are contemplated to be formed as polymeric sheathes, around which subdermal over-mold 11 layer is formed, or simply voids in the subdermal over-mold 11 layer, where space is present to accommodate movement of the corresponding part encapsulated therein. Where unoccupied negative space exists, low-density foam with mechanical properties similar to organic tissue may be utilized as subdermal over-mold 11 layer.

As it pertains to the illustrated portion of FIG. 2 below elbow joint 18, electronics assembly 24 is envisioned as placing the sensors, motors, wires, and other technologies required for movement together in a location directly on forearm skeletal element 14 so that electronics assembly 24 may be encapsulated by subdermal over-mold 11 during later stages of production via the utilization of a mold.

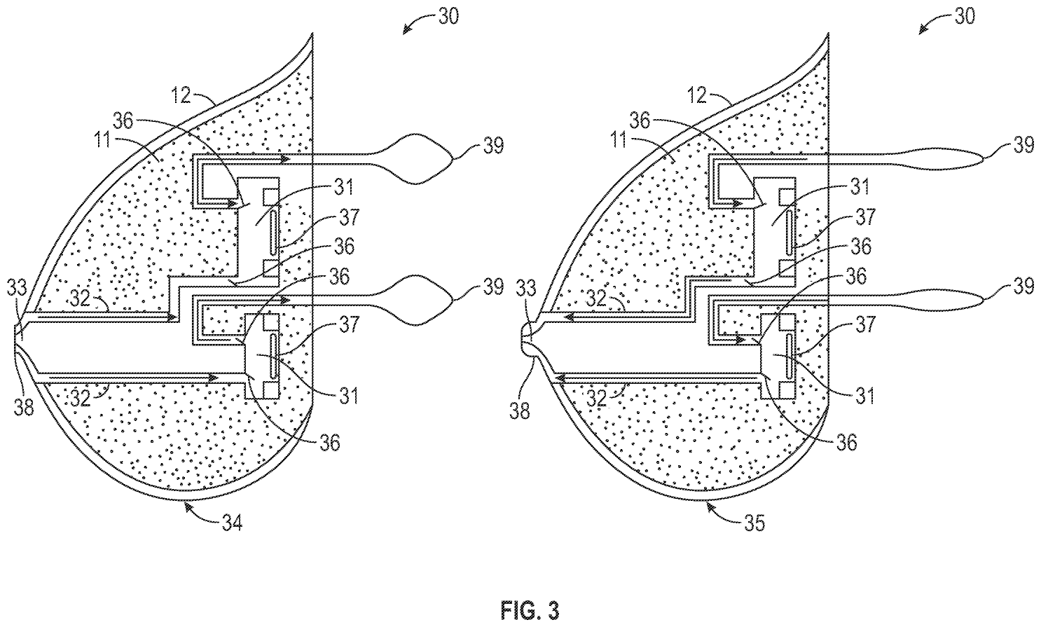

Referring next to FIG. 3, and its depiction of exemplary tumescence effectuated in an example embodiment of over-molded humanoid female breast 30. In this exemplary embodiment, fluid is pumped from internal fluid reservoir (not illustrated) into pump 31, housed within subdermal over-mold 11 beneath epidermal over-mold 12, to fill fluid channels 32 which lead directly to the exterior of the modular robotics system through humanoid nipple 33. As envisioned within this example embodiment, fluids are considered to be gases, but may take the form of liquids in other embodiments of the present invention. Humanoid nipple 33 may be devised, as illustrated in this exemplary embodiment, comparably to epidermal over-mold 12 where the use of silicone, TPE, or other unnamed but similarly considered polymers are utilized to resemble the look and feel of a human nipple. Regarding non-tumescent humanoid female breast 34, when humanoid nipple 33 is non-tumescent then internal fluid reservoir (not illustrated) is blocked from inserting fluid into pump 31 through fluid channels 32 by pump gates 36, thus guaranteeing that fluid sac 38 within humanoid nipple 33 is empty and flaccid.

Once the modular robotics system operator becomes “aroused”, non-tumescent humanoid female breast 34 transitions to tumescent humanoid female breast 35, and humanoid nipple 33 tumesces, causing fluid to be pumped from internal fluid reservoir (not illustrated) through fluid channels 32 into pump 31. As fluid fills pump 31, piezo diaphragm 37 causes pressure oscillations, via controlled opening and closing of pump gates 36, which pumps fluid through fluid channels 32 into fluid sac 38 of humanoid nipple 33, thus causing humanoid nipple 33 to swell and create the appearance of tumescence and in that way mimic the “arousal” experienced by the operator. While in this state, pump gates 36 remain closed, thereby keeping the fluid pressure stable and fluid sac 38 within humanoid nipple 33 engorged with fluid. When reverting from tumescent humanoid female breast 35 to non-tumescent humanoid female breast 34, piezo diaphragm 37 causes pressure oscillation, via controlled opening and closing of pump gates 36, to vent fluid from fluid sac 38 within humanoid nipple 33 through fluid channels 32 to internal fluid reservoir (not illustrated).

Also contemplated in FIG. 3 is the use of electroactive actuator reservoirs, or actuated reservoir 39, wherein oppositely charged walls of the reservoir attract to deform and thereby decrease the volume of the chamber. This change in volume will depend upon the intensity of the charge via introduced voltage, wherein operation may occur within a range of 1-12 KV. Since utilizing charged components within sensitive electrical systems can be troublesome, some of the polymeric material used in the formation of the dermal over-mold layers will act as potting with the addition of anti-static additives. From a mechanically operations perspective, the pneumatic/hydraulic system would be considered superior to the piezo diaphragm system.

In this way, as shown in FIG. 3, subdermal over-mold 11 and skin-like epidermal over-mold 12 layers mimic a response to stimuli or arousal experienced by a modular robotic system's operator. Tumescence of other portions of subdermal over-mold 11 and epidermal over-mold 12 are contemplated in like manner for their corresponding robotic parts, and will be similarly designed to resemble equivalent tumescence of the operator, such as the swelling of the labia and/or clitoris, the engorging of the penis, as well as other organs and features as may be added to a non-humanoid robot.

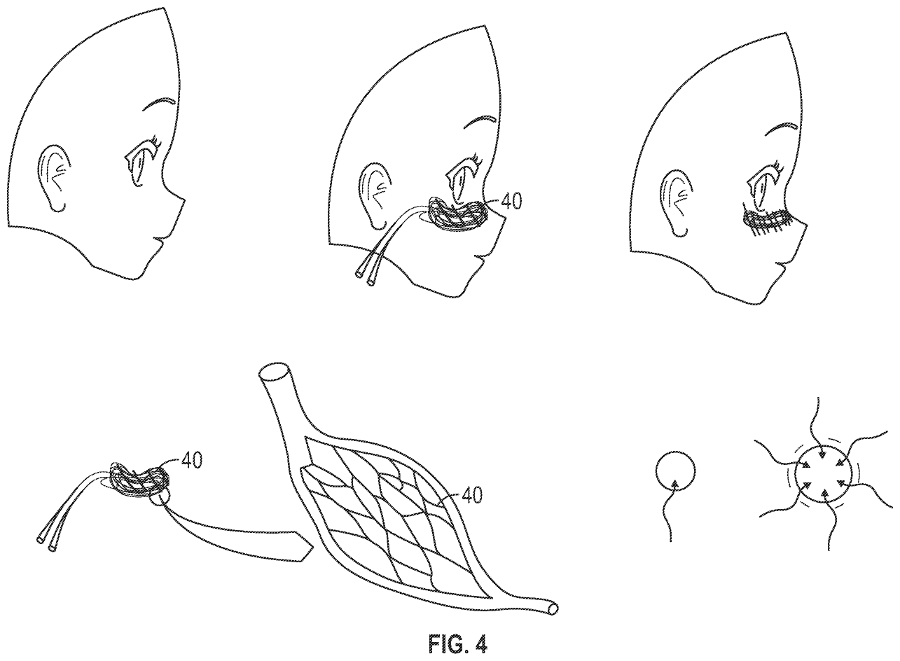

As illustrated in FIG. 4, aforementioned sacrificial material utilized in the fabrication of skin-like epidermal over-mold 12 layer will be removed during subsequent steps of the manufacturing process to create channels that can be utilized for the transference of fluids. This image depicts the use of these voided channels as blood capillary analogues 40, wherein a signal from the operator of a modular robotics system will cause a high flow of fluid to engorge the blood capillary analogue 40 walls. Which, in turn, will cause the subsurface light scattering effect depicted in FIG. 4 to occur beneath and within the polymeric skin-like epidermal over-mold 12 layer, thereby mimicking the reddening (or blushing) of the robotic system's face. The use of both sacrificial and non-sacrificial blood capillary analogues 40 is contemplated herein.

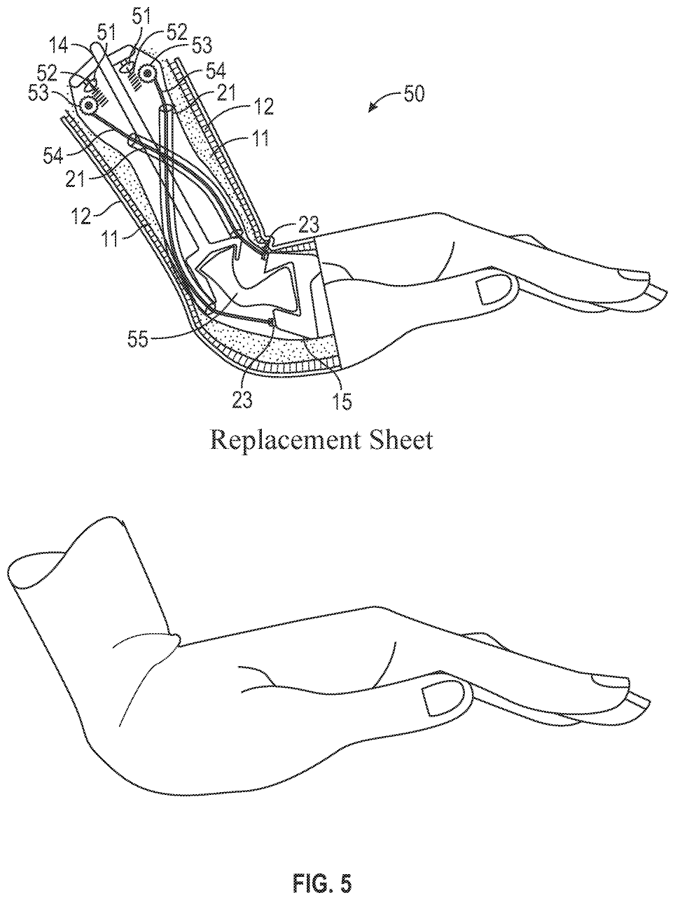

Referring next to FIG. 5, the illustration depicts an example embodiment of the present invention specifically relating to the construction of wrist joint 40 at the meeting point of forearm skeletal element 14 and carpal skeletal element 15 for the modular robotic system, including all requisite technological and molded components that enable wrist joint 40 movement needed for effective operation. Unlike in FIG. 1, the example embodiment presently shown in FIG. 5 depicts forearm skeletal element 14 with branched portions upon which are installed drone motors 41 attached to worm gears 42, disposed to interact with spoolers 43 that pull (or release) low friction filament material 44, which is fed through low friction conduit tubes 21. While FIG. 5 shows conduit tubes 21 intersecting behind forearm structural element 14, this is merely a singular embodiment shown here with other orientations of organizing these internal components considered by the present invention. Upon exiting conduit tube 21, filament material 44 attaches to anchor point 23 present at the end of carpal skeletal element 15. The resulting pulling, or releasing, of filament material 44 will result in changes of length thereof and cause flexing or bending of wrist joint 40. Similar to the creation of olecranon within the area adjacent to elbow joint 18, the modular compliant component present in the space between the ends of forearm skeletal element 14 and carpal skeletal element 15, hereinafter referred to as wrist nubby 45, strategically bends in proportion to the flexing of wrist joint 40 caused by the pulling of filament material 44 on anchor points 23.

The entire collection of structural and technological components stated and described above, as illustrated within FIG. 5, is encapsulated by subdermal over-mold 11, which is itself encompassed by skin-like epidermal over-mold 12. Although not specifically shown in FIG. 5, skin-like epidermal over-mold 12 can be tuned with negative space and matrix ingress to allow for a biomimetic effect akin to wrinkling, which naturally occurs to a human body during bending of joints. Additionally, another layer of foam placed underneath some areas of skin-like epidermal over-mold 12 may be contemplated in some embodiments to mollify the effect of continuous bending causing creases and stress/strain fracturing, while further assisting in the mimicry of operator's biomechanical movements, thus allowing for a high quality and fully immersive experience.

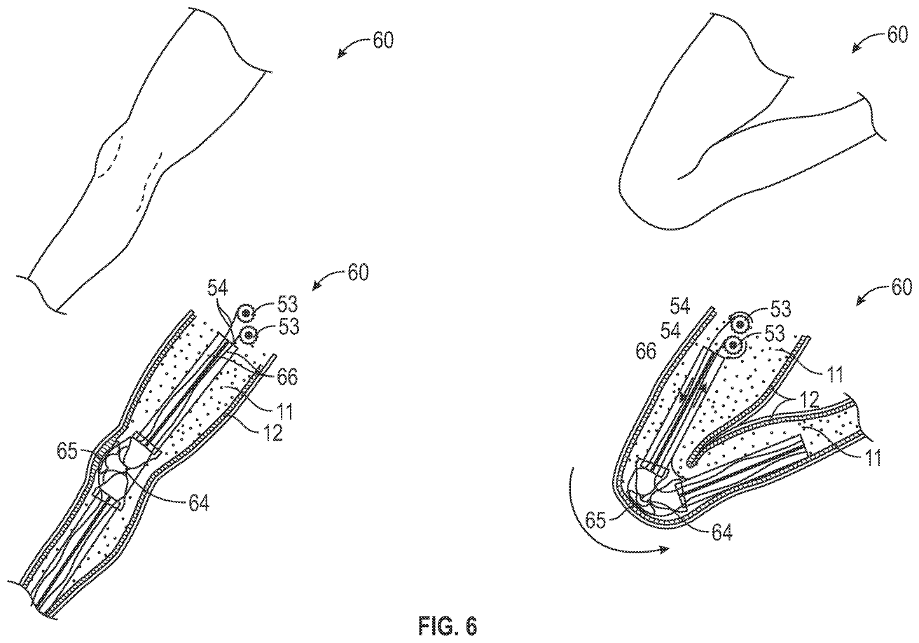

Turning next to FIG. 6, the illustration depicts an example embodiment of a modular robotic system's humanoid leg 50 specifically relating to the construction of knee joint 51 situated betwixt femur skeletal element 52 and shin skeletal element 53, a singular skeletal framework portion that replicates both a human leg's tibia and fibula bones. Like in FIG. 5, the FIG. 6 illustration depicts all technological and molded components required to enable knee joint 51 movements thus allowing effective operation of the modular robotic system. However, unlike in FIG. 5, the FIG. 6 illustration depicts a contemplated embodiment wherein the robotic system's solid skeletal framework is replaced by hollow skeletal tubes 66 constructed from woven carbon fiber or a stiff polymer, such as PLA, but other embodiments may utilize a variety of materials both polymer-based and otherwise (such as wood in a biodegradable embodiment of the instant invention).

Through skeletal tubes 66, spoolers 43 drive tensile filament material 44 to cause tension and flexion of knee joint 51. Similar to wrist nubby 45 of wrist joint 40, knee joint 51 must contain a modular compliant insert, or knee nubby 54, that will perform the geometric and tensile role of the comparative human knee joint's ligaments, while also allowing for compressive performance and withstanding of large loads of force. As shown in previous Figures, subdermal over-mold 11 encapsulates the area surrounding skeletal tubes 66 as well as the areas both above and below knee joint 51, while epidermal over-mold 12 encapsulates that subdermal over-mold 11. While the material makeup of subdermal over-mold 11 may utilize the same polymeric molding (either low or high density depending on the specific area and level of aeration) in FIG. 6, this presently depicted example embodiment contemplates the use of foam urethane, or biodegradable plant-derived foam latex as a recyclable alternative. Likewise, epidermal over-mold 12 is envisioned within FIG. 6 as utilizing the same silicone-based polymer molding material as is mentioned above, but may also utilize strategic blends of various components that share a solubility group (such as latex, PLA, Epoxidized triglycerides, or starches) as a biodegradable recyclable alternative. However, unlike previous Figures disclosed herein, knee joint 51 requires a considerably larger amount of space to operate while also requiring a kneecap/patella analogue, hereinafter humanoid patella 55. The modular robotics system utilizes a simplification of a human knee joint's cam-like structure to achieve the biomimetic, mobile patella functionality via the use of humanoid patella 55, which spans the Femur-Condyle and Shin-Meniscus analogue. As such, the protrusions of these analogues push humanoid patella 55 outwards when knee joint 51 is extended and allow humanoid patella 55 to sink in when knee joint 51 is bent.

Fabrication of humanoid patella 55, as shown in example embodiment illustration FIG. 6, employs a nylon matrix layer that allows moderated ingress via permeability in the negative space above knee joint 51. This nylon matrix is biomimetic of patellar ligaments and/or rectus femoris tendons.

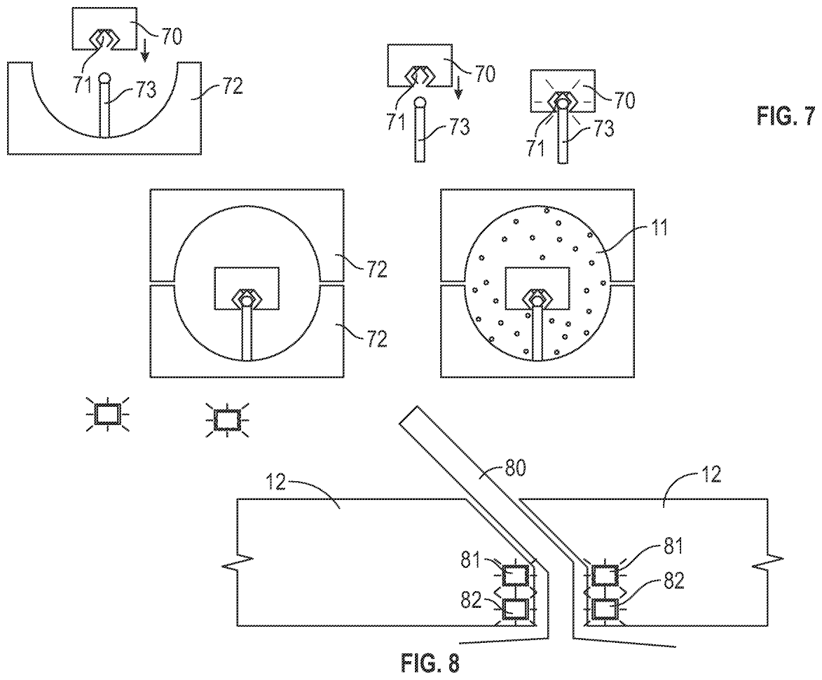

Referring next to FIG. 7, the illustration depicts one of the exemplary embodiments envisioned for the method of fabricating subdermal over-mold 11 around the modular robotic system's skeletal framework 70. During creation of skeletal framework 70, compliant sockets 71 are strategically left within each of the individual portion. These compliant sockets 71 act as anchoring points for mold protrusions 73, which are attached to each individual mold 72. Similar to FIG. 1's scaffolding protrusions 19, these mold protrusions 73 will hold skeletal framework 70 in place while subdermal over-mold 11 encompasses the entirety of its body. In addition to leaving voids, channels, and negative space within subdermal over-mold 11, mold protrusions 73 ensure consistency of fabrication in addition to offering specific areas of the polymeric layer than can be opened up for maintenance, repair, and modification. Although not specifically illustrated in FIG. 7, the interior of mold 72 will mimic the overall shape and structure of the musculature being represented by the modular robotic system, as opposed to merely creating uniformly rounded subdermal over-mold 11 layers.

Turning next to FIG. 8, an exemplary embodiment of hair follicle 80 made from photo-cured polymeric resin protruding through skin-like epidermal over-mold 12 layer is shown. During the fabrication process of skin-like epidermal over-mold 12 layer, the use of sacrificial material (as previously mentioned) is contemplated to form fluidic channels that will house and help transfer analogues of blood, sweat, tears, and other fluids throughout the modular robotic system. As contemplated in conjunction with, and placed adjacent to, these channels, matrices of micro silvered LEDs 81 and unsilvered LEDs 82 will be housed within skin-like epidermal over-mold layer 12. In every embodiment contemplated herein, the matrices of unsilvered LEDs 82 will be placed beneath the matrices of silvered LEDs 81.

After fabrication, via curing and setting, of skin-like epidermal over-mold 12 layer is complete, said sacrificial material may be removed to reveal fillable channels created therein into which uncured polymeric photo-resin may be injected. As the resin escapes through the individual channels, the growth of hair follicle 80 can be controlled via the use of both silvered LEDs 81 and unsilvered LEDs 82 matrices. Unsilvered LEDs 82 locally solidify, via curing, the follicle channel by freely allowing light in the space below and all around it thereby halting the growth of any hair follicle 80 within the range of its light. This causes locally cured resin to intentionally clog the base of hair follicle 80. Whereas silvered LEDs 81 only give off light uni-directionally thereby solidifying the light sensitive polymeric photo-resin inside hair follicle 80 and imputing upon it a hair-like shape, without the light affecting the reservoir of uncured resin below.

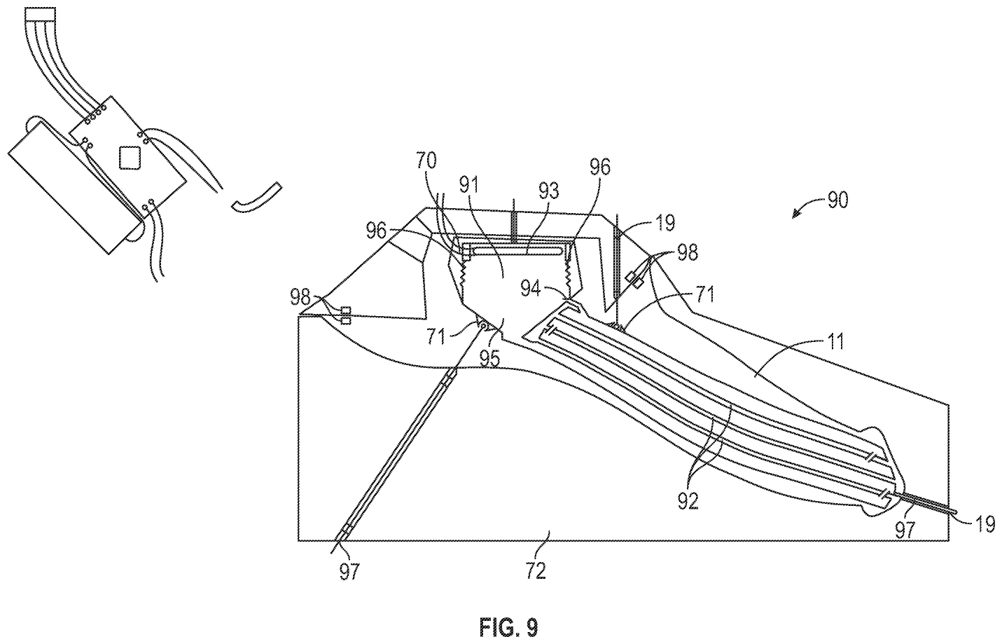

Referring lastly to FIGS. 9 and 10, this illustration depicts a humanoid phallus 90 wherein a pressure differential is created between pump chamber 91 and phallus tubules 92, thereby producing the capability of simulating an erection via piezo diaphragm 93. This is accomplished by having a large entryway and small exit check valve 94, which allows the pressure to build up within phallus tubules 92 or to decrease by actuation of piezo diaphragm 93. Accordion oscillators 96 are located adjacent, and connected, to piezo diaphragm 93 and assist in causing humanoid phallus 90 to experience an erection by creating pressure oscillations in the fluid present. As accordion oscillators 96 compress and lose fluid from pump chamber 91, the differential between the larger entryway 95 and smaller exit check valve 94 causes a buildup of fluid within humanoid phallus 90, specifically within phallus tubules 92. Once accordion oscillators 96 relax, and piezo diaphragm 93 ceases its operation, the fluid within phallus tubules 92 flows back into pump chamber 91 via exit check valve 94, and stays there as entryway 95 remains closed. Additionally contemplated herein is the inclusion of a HASEL bladder, or fluid sac, within humanoid phallus 90 for the ejaculation of urine or semen analogues upon receiving an electrical signal from the modular robotic system's operator.

As shown in FIG. 9, similar to FIG. 1, scaffolding protrusions 19 pierce mold 72 to hold the underlying skeletal framework 70, in this instance humanoid phallus 90, in place while subdermal over-mold 11 encapsulates and encompasses it. As seen in previous Figures, scaffolding protrusions 19 are able to attach to underlying skeletal framework 70 via compliant socket 71. Scaffolding protrusions 19 may also be used without compliant sockets 71, such as where voids or channels need to be intentionally created, and in FIG. 9 this manner of using scaffolding protrusions 19 can be seen at the head of humanoid phallus 90 where it is being used to create ureteral channel 97. Regardless of which part of the humanoid body is being formed or fabricated, scaffolding protrusions 19, whether in the shape of blades, needles, screws, or a combination thereof, allow for precise adjustments to exact position of the internals to be made during the over-mold fabrication process.

Unlike in the exemplary embodiment of FIG. 7, where mold 72 includes affixed scaffolding protrusions 19 and the halves of mold 72 are mechanically held together during the subdermal over-mold 11 fabrication process, the contemplated embodiment of FIG. 9 has mold 72 comprising magnets 98 capable of holding both halves together during the fabrication process. In addition to holding together parts of mold 72, magnets 98 can occupy space that will be kept devoid of material and they can be used to hide seams that will be created during the fabrication process.

Aside from the exemplary embodiments described in detail above, the industrial applicability of this over-mold system, and method of fabrication, can be utilized to improve a myriad of robotic system elements and the efficiencies thereof.

What is claimed is:

1. Over-mold layers encapsulating a modular robotics system, comprising:
a modular robotic system's framework comprised of electronic and technological components embodying the skeletal bones, as well as the muscular ligaments and tendons of a human, animal, or fantastical creature's body;
a polymeric subdermal over-mold layer disposed overtop of said modular robotic system's framework;
a polymeric epidermal over-mold layer disposed over top of said subdermal over-mold layer;
wherein the polymeric subdermal over-mold layer encompasses and encapsulates the robotic skeletal framework and all surrounding electrical or technological components present thereon or attached thereto; and
wherein the polymeric epidermal over-mold layer encompasses and encapsulates said subdermal over-mold, such that it renders a contouring similar in appearance and tactility equivalent to portions of the human, animal, or fantastical form.

2. The over-mold layers of claim 1, further comprising:
non-electrical, pneumatic, or hydraulic components encapsulated within the subdermal over-mold, said components configured to biomimetically operate equivalent to animal organs capable of tumescence, including growth, engorgement, and excretion of fluids.

3. The over-mold layers of claim 2, wherein said fluids are pulled from an internal reservoir encapsulated within the subdermal over-mold, or from the ambient exterior of the present invention, via pressure differentials, piezo-diaphragms, valve pumps, and actuators that are stored within a bladder sac within the organ effecting tumescence.

4. The over-mold layers of claim 1, further comprising:
a robotic framework of polymeric sheaths, conduit tubes, and solid tubes as representative of bones within the skeletal system of the creature being embodied by the modular robotics system; and
hydraulically amplified self-healing electrostatic actuators in combination with polymeric sheathes

5. The over-mold layers of claim 1, wherein the subdermal over-mold and epidermal over-mold are comprised of aerated polymeric foam, of varying densities such that low-density material is utilized to reduce mass and thereby reduce latency of action, while high-density material is utilized to provide additional rigidity and load-bearing support to joints and other portions of the robotics framework as required.

6. The over-mold layers of claim 1, wherein the epidermal over-mold is rendered of an adjustably soft and yielding polymeric material configured to biomimetically simulate animal skin, including human, avian, reptilian, amphibian, glabrous or hairy mammalian skin, or fantastical skin. The over-mold layers of claim 1, wherein the subdermal and epidermal over-mold layers further comprise voids and spacing configured as orifices or conduits wherein fluids may secrete, excrete, ejaculate, ooze, or exude from orifices, pores, ducts, or other equivalent animal tissue.

8. The over-mold layers of claim 1 further comprising exaggerated and/or fantastical parts, members, or anatomical structures reminiscent of creatures or any combination thereof.

9. The over-mold layers of claim 1 wherein the subdermal over-mold includes voids, spacing, housings, and/or conveyances to accommodate rigid and/or semi-rigid robotic hardware configured to mimic biomechanical operations, movements, and/or locomotion, wherein the voids enable precision injection or position of material or structures at targeted locations such as proximal to joints and load-bearing anatomy.

10. Biodegradable over-mold layers encapsulating a recyclable modular robotics system comprising:
a recyclable robotic framework of electronic and technological components embodying the skeletal bones, muscular ligaments, and tendons of a human, animal, or fantastical creature's body;
a biodegradable polymeric subdermal over-mold disposed and cured overtop said robotic skeletal and technological framework;
a biodegradable polymeric epidermal over-mold disposed and cured overtop said subdermal over-mold;
wherein the polymeric subdermal over-mold encompasses and encapsulates said robotic skeletal framework and all surrounding electronic and technological components attached thereto or otherwise present; and
wherein the polymeric epidermal over-mold encompasses and encapsulates said subdermal over-mold and renders contouring similar in appearance and tactility in mimicry of portions of the human, animal, or fantastical form embodied.

11. The method of manufacturing over-mold layers upon a robotic framework, comprising the steps of:
liquefying silicone-based photo-resin polymer;
affixing a modular robotic system framework within molds via scaffolding protrusions, mold protrusions, screen meshes, or other stabilizing means;
encapsulating whole or part of the modular robotic system framework within a subdermal over-mold material, followed by a curing and setting period;
selectively reducing negative mold space to accommodate voids for injections and ancillary molding steps;
affixing the over-molded modular robotic system framework within molds via scaffolding protrusions, mold protrusions, screen meshes, or other stabilizing means;
injection molding of discrete material to biomimetically configure biomechanical operation of joints and other anatomical structures;
encapsulating the subdermal over-molded portion of said modular robotic framework with epidermal over-mold, followed by a curing and setting period;
removing the means of affixation once the over-mold has cured and/or hardened;
removing sacrificial material utilized during fabrication process; and
configuring voids rendered interior to the over-mold for selective passage of fluids to create biomimetic capillaries, fluid channels, and/or orifices.
